(19) United States
(12) Patent Application Publication
(10) Pub. No.: US 2014/0082754 A1
(43) Pub. Date: Mar. 20, 2014

(54) ELECTRONIC DEVICE AND METHOD FOR DISABLING APPLICATION AND HARDWARE

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: MING-RUI GUO, Shenzhen (CN); QING WANG, Shenzhen (CN); WEN-HAO SHI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/859,750

(22) Filed: Apr. 10, 2013

(30) Foreign Application Priority Data
Sep. 14, 2012 (CN) 201210339881.0

(51) Int. Cl. G06F 21/00

(52) U.S. Cl. CPC G06F 21/00
USPC 726/30

(57) ABSTRACT

An electronic device includes a storage unit, a positioning unit, and a processing unit. The storage unit stores geographic information for defining various restricted areas and a disabling table recording one or more to-be-disabled applications and/or hardware of the electronic device in each restricted areas. The positioning unit positions the electronic device. The processing unit determines whether the electronic device enters one restricted area according to the position of the electronic device and the geographic information for defining the various restricted areas, determines one or more to-be-disabled applications and/or hardware according to the disabling table when the electronic device enters one restricted area, and disable the determined one or more to-be-disabled applications and/or hardware when the electronic device enters the one restricted area. A related method is also provided.

### BACKGROUND

1. Technical Field

The present disclosure relates to electronic devices and, particularly, to an electronic device capable of disabling applications and hardware of the electronic device and a method thereof.

2. Description of Related Art

To avoid leakage of confidential information, some companies or factories forbid employees to use electronic devices (e.g. smart phones) in restricted areas. This can avoid leakage of confidential information, but may also bring inconvenience to employees. For example, in a photography-prohibited area, cameras are prohibited, but communication is allowed. If smart phones having cameras are prohibited, communication between employees may be limited. Therefore, a method to solve the above problems is desired.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device for disabling applications and hardware, in accordance with an exemplary embodiment.

FIG. 2 is a flowchart of a method for disabling applications and hardware, in accordance with an exemplary embodiment.

### DETAILED DESCRIPTION

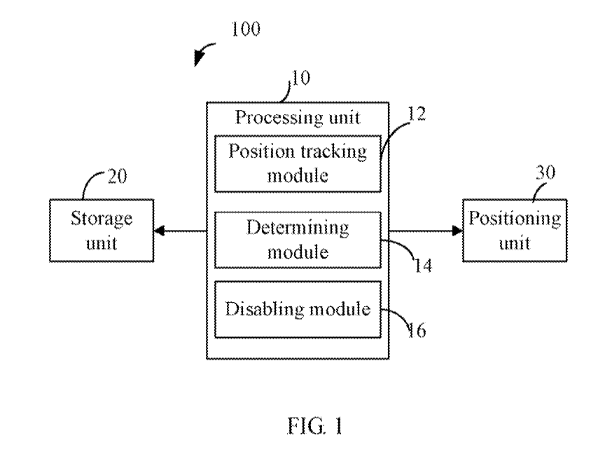

FIG. 1 shows an embodiment of an electronic device 100. The electronic device 100 is used for disabling applications (e.g. email) and hardware (e.g. camera) of the device 100 when the device 100 is in restricted areas. The device 100 may be a smart phone, or a handheld computer. The device 100 includes a processing unit 10, a storage unit 20, and a positioning unit 30. The storage unit 20 stores geographic information for defining various restricted areas and a disabling table. The disabling table records one or more to-be-disabled applications and/or hardware in each restricted area. The positioning unit 30 is used to locate position of the device 100. In this embodiment, the positioning unit 30 is a GPS unit.

The processing unit 10 includes a position tracking module 12, a determining module 14, and a disabling module 16. The position tracking module 12 determines whether the device 100 enters one restricted area according to the position of the device 100 and the geographic information for defining various restricted areas. The determining module 14 determines one or more to-be-disabled applications and/or hardware according to the disabling table when the device 100 enters one restricted area. The disabling module 16 disables the one or more determined to-be-disabled applications and/or hardware when the device 100 enters the one restricted area, and re-enables the disabled applications and/or hardware when the device 100 leaves the one restricted area.

In this embodiment, the disabling module 16 disables one to-be-disabled hardware by calling applications for supporting the running of the to-be-disabled hardware, and re-enables the disabled hardware by releasing the called applications. If the applications for supporting the running of the to-be-disabled hardware are called by the disabling module 16, the to-be-disabled hardware cannot be started by clicking the application icon of the to-be-disabled hardware. For example, if the to-be-disabled hardware is a camera, when the disabling module 16 disables the camera, users cannot open the camera to take photos. In this embodiment, the disabling module 16 disables one to-be-disabled application by hiding an operation interface of the to-be-disabled application when the to-be-disabled application is opened, and re-enables one disabled application by re-displaying the operation interface of the disable application. Other methods for disabling applications and hardware can also be employed.

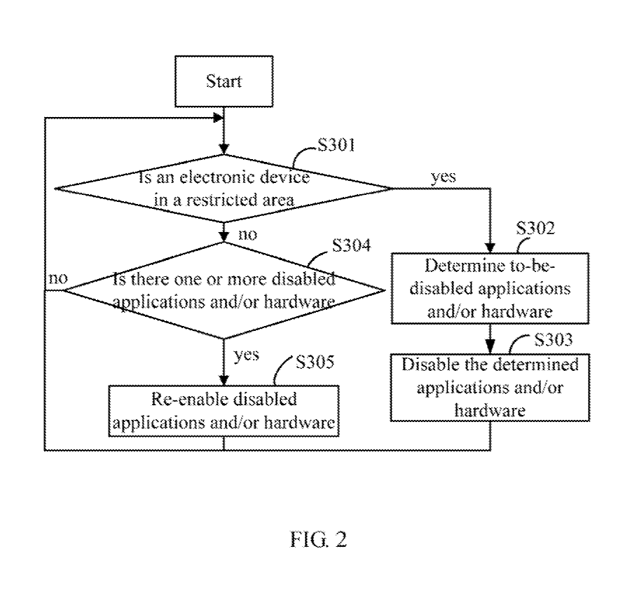

FIG. 2 is a flowchart of a method for disabling applications and hardware of the device 100, in accordance with an exemplary embodiment.

In step S301, the position tracking module 12 determines whether the device 100 enters one restricted area according to the position of the device 100 and the geographic information for defining various restricted areas. If yes, the procedure goes to step S302, otherwise the procedure goes to step S303.

In step S302, the determining module 14 determines one or more to-be-disabled applications and/or hardware according to the disabling table.

In step S303, the disabling module 16 disables the one or more determined to-be-disabled applications and/or hardware. After executing step S303, the procedure returns to step S301.

In step S304, the disabling module 16 determines there is one or more disabled applications and/or hardware of the device 100 when the device 100 is not in any restricted area. If yes, the procedure goes to step S305, otherwise the procedure returns to step S301.

In step S305, the disabling module 16 re-enables the one or more disabled applications and/or hardware. After executing step S305, the procedure returns to step S301.

With such configuration, when the electronic device 100 enters a restricted area, some applications and/or hardware which may bring leakage of confidential information are automatically disabled, thus information leakage is avoided. Thus, the electronic device 100 can be used to help person's work without information leakage.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device for disabling applications and hardware, comprising:
a storage unit storing geographic information for defining various restricted areas and a disabling table recording one or more to-be-disabled applications and/or hardware of the electronic device in each of the restricted areas;
a positioning unit to locate the position of the electronic device; and
a processing unit comprising:
a position tracking module to determine whether the electronic device enters one of the restricted areas according to the position of the electronic device and the geographic information;
a determining module to determine one or more to-be-disabled applications and/or hardware according to the disabling table when the electronic device enters one of the restricted area; and
a disabling module to disable the determined one or more to-be-disabled applications and/or hardware when the electronic device enters the one of the restricted area.

2. The electronic device as described in claim 1, wherein the disabling module is further to re-enable the one or more disabled applications and/or hardware when the electronic device leaves the one of the restricted area.

3. The electronic device as described in claim 1, wherein the disabling module is to disable each of the determined one or more to-be-disabled hardware by calling applications for supporting the running of each of the one or more determined to-be-disabled hardware.

4. The electronic device as described in claim 1, wherein the disabling module is to disable each of the determined one or more to-be-disabled applications by hiding an operation interface of each of the determined one or more to-be-disabled applications when each of the determined one or more to-be-disabled applications is opened.

5. A method for disabling applications and/or hardware applied in an electronic device, the electronic device comprising a storage unit and a positioning unit, the storage unit storing geographic information for defining various restricted areas and a disabling table recording one or more to-be-disabled applications and/or hardware of the electronic device in each of the restricted areas, the positioning unit being to locate the position of the electronic device, the method comprising:
determining whether the electronic device enters one of the restricted areas according to the position of the electronic device and the geographic information;
determining one or more to-be-disabled applications and/or hardware according to the disabling table when the electronic device enters one of the restricted area; and
disabling the determined one or more to-be-disabled applications and/or hardware when the electronic device enters the one of the restricted area.

6. The method as described in claim 5, further comprising:
re-enabling the one or more disabled applications and/or hardware when the electronic device leaves the one of the restricted area.

7. The method as described in claim 5, wherein disabling the one or more determined hardware comprises: disabling each of the determined one or more to-be-disabled hardware by calling applications for supporting the running of each of the one or more determined to-be-disabled hardware.

8. The method as described in claim 5, wherein disabling each of the one or more determined application comprises: disabling each of the determined one or more to-be-disabled applications by hiding an operation interface of each of the one or more determined to-be-disabled applications when each of the determined one or more to-be-disabled applications is opened.
